(19) United States
(12) Patent Application Publication
(10) Pub. No.: US 2026/0296030 A1
(43) Pub. Date: Oct. 1, 2026

(54) HEAD CLEANING JIG

(71) Applicant: SEIKO EPSON CORPORATION, Tokyo (JP)

(72) Inventors: Osamu MURAYAMA, Yamagata-mura (JP); Shuichiro NAKANO, Matsumoto-shi (JP); Hiroyuki NAKAYAMA, Shiojiri-shi (JP)

(21) Appl. No.: 19/576,666

(22) Filed: Mar. 24, 2026

(30) Foreign Application Priority Data
Mar. 25, 2025 (JP) 2025-049486

(51) Int. Cl. B41J 2/165

(52) U.S. Cl. CPC B41J 2/16544; B41P 2235/20

(57) ABSTRACT

A head cleaning jig includes a guide rib configured to follow at least one side of a head that has a rectangular shape and ejects liquid, and a holding section that holds a cleaning member for wiping nozzles arranged along the one side. The nozzles and the cleaning member held by the holding section are configured to be brought into contact with each other in a state where the guide rib follows the one side.

The present application is based on, and claims priority from JP Application Serial Number 2025-049486, filed Mar. 25, 2025, the disclosure of which is hereby incorporated by reference herein in its entirety.

### BACKGROUND

### 1. Technical Field

The present disclosure relates to a head cleaning jig.

### 2. Related Art

In the related art, it is known that maintenance work is performed on an ink jet head in a large-format printer or the like. For example, JP-A-2008-162174 discloses an ink jet recording apparatus provided with a mirror for observing a lower surface of a recording head during the maintenance work.

However, in the apparatus described in JP-A-2008-162174, there is a problem that it is difficult to improve workability of maintenance. More specifically, the recording head is cleaned using a cleaning tool while the recording head is observed with the mirror. Therefore, when the periphery of a nozzle is cleaned, it is not easy to position the cleaning tool at the position of the nozzle. In other words, a head cleaning jig that improves the workability of the maintenance has been desired.

### SUMMARY

A head cleaning jig includes a guide rib configured to follow at least one side of a head that has a rectangular shape and ejects liquid, and a holding section that holds a cleaning member for wiping nozzles arranged along the one side. The nozzles and the cleaning member held by the holding section are configured to be brought into contact with each other in a state where the guide rib follows the one side.

### BRIEF DESCRIPTION OF THE DRAWINGS

FIG. 1 is a schematic sectional view illustrating a configuration of a printing apparatus according to an embodiment.

FIG. 2 is a schematic front view illustrating the configuration of the printing apparatus.

FIG. 3 is a plan view illustrating a configuration of a head.

FIG. 4 is an enlarged sectional view taken along line IV-IV in FIG. 3.

FIG. 5 is a perspective view illustrating a configuration of a head cleaning jig.

FIG. 6 is a perspective view illustrating the configuration of the head cleaning jig.

FIG. 7 is a perspective view illustrating an appearance of the head cleaning jig to which a cleaning member is attached.

FIG. 8 is a schematic plan view illustrating the correspondence between nozzle rows of the head and holding sections.

FIG. 9 is a perspective view illustrating a posture of the head cleaning jig in contact with the head during maintenance work.

FIG. 10 is a schematic sectional view illustrating a unit for positioning the head cleaning jig, and the like.

FIG. 11 is a schematic sectional view illustrating another unit for positioning the head cleaning jig.

### DESCRIPTION OF EMBODIMENTS

In the embodiment described below, a printing apparatus 1 and a head cleaning jig 100 used for maintenance work of the printing apparatus 1 will be exemplified and described with reference to the drawings. The printing apparatus 1 is a large-format ink jet printer. The head cleaning jig of the present disclosure is not limited to being applied to a large-format ink jet printer.

In each of the following figures, X-, Y-, and Z-axes are indicated as coordinate axes orthogonal to each other, and the direction indicated by each arrow is defined as a + direction, and a direction opposite to the + direction is defined as a − direction. In the present embodiment, a state in which the printing apparatus 1 is installed on a horizontal surface such as a floor will be described, and a +Z direction will also be referred to as upward, and a −Z direction will also be referred to as downward. In the above state, the −Z direction coincides with a vertical direction. Further, in each of the following figures, for convenience of illustration, the size of each member is different from the actual size.

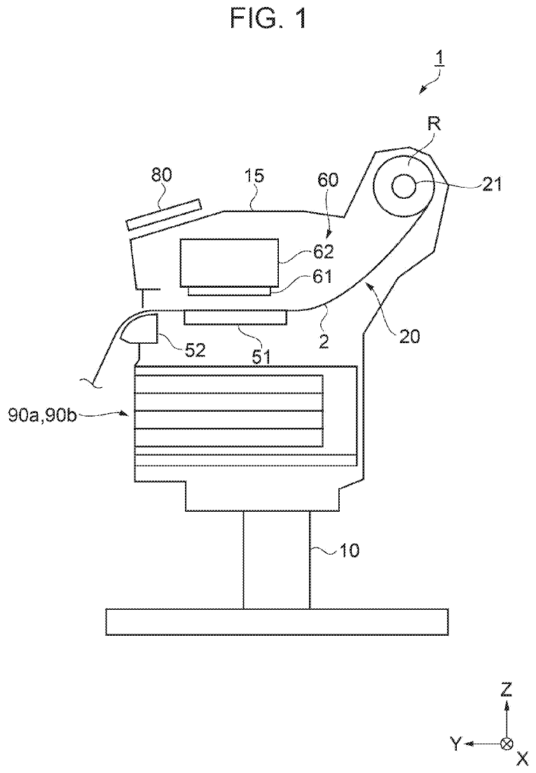

As illustrated in FIG. 1, the printing apparatus 1 according to the present embodiment includes a structural member 10, a housing 15, a transport section 20, a medium support section 51, a printing section 60, and liquid supply sections 90a and 90b. The housing 15 is an exterior member of the printing apparatus 1 and accommodates the above-described components inside the housing 15. The printing apparatus 1 also includes an operation panel 80 and a controller (not illustrated). In the description of FIG. 1, a state viewed from a −X direction will be described unless otherwise specified.

The printing apparatus 1 produces a printed matter by attaching liquid such as ink to a medium 2 which is a continuous form sheet. In the printing apparatus 1, the medium 2 is fed out from a roll body R which is an original sheet, printed on the medium 2, and discharged from the printing apparatus 1.

A movement path of the medium 2 along which the medium 2 is fed out from the roll body R and discharged is referred to as a transport path. In the transport path, the side of the roll body R of the medium 2 is also referred to as an upstream side, and the side on which the medium 2 advances is also referred to as a downstream side. In the transport path, the roll body R, the medium support section 51 and the printing section 60, and a medium support section 52 are disposed in this order from the upstream side to the downstream side. In the transport path, a direction in which the medium 2 is transported from the upstream side to the downstream side is also referred to as a transport direction.

The controller is electrically connected to each component of the printing apparatus 1 and integrally controls the operations of the above-described components. The controller includes hardware such as a central processing unit (CPU), a read only memory (ROM), and a random access memory (RAM). The controller controls the printing apparatus 1 by causing the CPU to execute a predetermined control program. The ROM is a nonvolatile storage device, and stores a control program executed by the CPU and data processed by the control program. The RAM constitutes a work area of the CPU. The CPU expands a control program read from the ROM or the like in the RAM, and executes the expanded control program to control the printing apparatus 1.

The operation panel 80 is supported by the structural member 10 via a member (not illustrated), and is disposed at an upper end section of the housing 15 in a +Y direction. The operation panel 80 is electrically connected to the controller. The operation panel 80 not only displays various types of information but also accepts inputs of various operations and various settings by a user of the printing apparatus 1. The operation panel 80 is, for example, a touch panel type liquid crystal display. The operation panel 80 may include a physical button in addition to the liquid crystal display.

The structural member 10 is a frame that supports the above-described components of the printing apparatus 1. The structural member 10 is assembled with a plurality of sheet metal members, tubular members, and the like. The structural member 10 is equipped with a caster, an installation member, or the like at a portion which comes into contact with a lower floor.

The transport section 20 includes a roll body holding section 21, the medium support section 52, and a plurality of transport rollers (not illustrated). The roll body holding section 21 supports the roll body R such that the roll body R can rotate about an axis along the X-axis. The roll body holding section 21 is disposed on the upper side of the printing apparatus 1 so as to protrude upward in a −Y direction. The medium 2 is pulled by the transport rollers, and is fed out and supplied to the downstream side from the roll body R. The roll body R is attachable to and detachable from the printing apparatus 1. The medium 2 is transported substantially downward from the roll body holding section 21 and advances to the medium support section 51.

The transport rollers are disposed at various positions in the transport path and transport the medium 2. Each of the transport rollers includes, for example, a driving roller rotationally driven by an electric motor, and a driven roller driven by the driving roller. The driving roller and the driven roller each rotate about an axis along the X-axis. The medium 2 is transported while being put between the driving roller and the driven roller.

The medium 2 is appropriately selected depending on the type of liquid such as ink to be attached to the medium 2, the use of the printed matter, and the like. Examples of the ink include aqueous ink, non-aqueous ink, electron beam curable ink, and the like. As the medium 2, cloth, a resin film, a resin sheet, coated paper, or the like is used. An upward-facing surface of the medium 2 supported by the medium support section 51 is a printing surface, and is a surface on which the ink is attached and printing is performed. The medium 2 is not limited to a continuous form, and may be a cut sheet or a sewn product such as a T-shirt. In a case where the medium 2 other than the continuous form is used, the configurations of the transport section 20 and the like may be different from that described above.

The medium support section 51 comes into contact with a lower surface of the medium 2 opposite to the printing surface, and supports the medium 2. The medium support section 51 is a so-called platen. An upper surface of the medium support section 51 is along an XY plane. In the medium support section 51, the transport direction of the medium 2 is the +Y direction. The liquid supply sections 90a and 90b are disposed below the medium support section 51.

The medium support section 51 may incorporate an electric heater that heats the medium 2. The electric heater heats the medium 2 to improve fixability of ink or the like to the medium 2 and to promote volatilization of a volatile component such as water contained in the liquid such as ink.

The printing section 60 performs printing on the medium 2. The printing section 60 includes a head 61 and a carriage 62. The printing section 60 is disposed above the medium support section 51. The carriage 62 is supported by the above-described structural member 10 so as to be able to reciprocate along the X-axis. The carriage 62 reciprocates along the X-axis by being driven by a carriage motor (not illustrated). The carriage 62 supports the head 61 such that the head 61 faces the medium support section 51.

The head 61 ejects and attaches the liquid such as ink to the printing surface of the medium 2 supported by the medium support section 51. The head 61 reciprocates, together with the carriage 62, along the X-axis in a range including a region facing the medium support section 51 in the up-down direction.

Although not illustrated, a nozzle surface is disposed on a surface of the head 61 facing downward. A plurality of nozzle rows are provided on the nozzle surface. Each of the nozzle rows includes a plurality of nozzles that eject the liquid such as ink. The liquid supply sections 90a and 90b each supply the liquid to each of the nozzle rows according to the type of ink or the like.

In the head 61, a piezoelectric element is used as an actuator which is a drive unit. The drive unit is not limited to this. As the drive unit, for example, an electromechanical conversion element that displaces a vibrating plate as an actuator by electrostatic adsorption, or an electrothermal conversion element that causes ink to be ejected as liquid droplets by air bubbles generated by heating may be used.

In the medium support section 51, the medium 2 is transported in the +Y direction while the head 61 is reciprocated along the X-axis together with the carriage 62. At this time, the liquid such as ink is attached to the printing surface of the medium 2 at an arbitrary timing, and an image such as a picture, a photograph, a text, or a pattern is printed on the medium 2. The medium 2 on which printing has been performed is transported from the medium support section 51 to the medium support section 52.

The medium support section 52 has a curved surface and the curved surface comes into contact with the lower surface of the medium 2 being transported to support the medium 2. The medium 2 is transported while sliding in contact with the curved surface of the medium support section 52. The transport direction of the medium 2 is changed by the curved surface of the medium support section 52 from the +Y direction to a direction slightly downward from the +Y direction.

The medium support section 52 may incorporate an electric heater that heats the medium 2. The electric heater heats liquid droplets such as ink applied to the medium 2 to promote volatilization of volatile components such as water contained in the liquid droplets.

The medium 2 that has become a printed matter is discharged from the printing apparatus 1 in the +Y direction via the medium support section 52. In this way, a printed matter is produced. The printing apparatus 1 may include a medium cutting section in the vicinity of the medium support section 52 to cut the printed matter along the X-axis. In addition, the printed matter may be cut along the X-axis after being discharged from the printing apparatus 1, or may be transported to a post-processing apparatus or the like. Further, the printed matter may be subjected to secondary processing such as transfer processing.

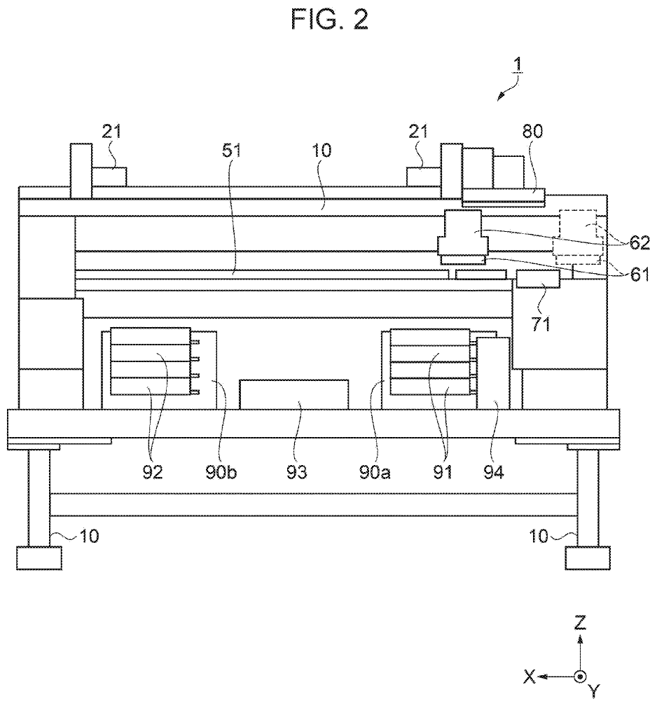

As illustrated in FIG. 2, the printing apparatus 1 includes a liquid sending section 93, a liquid circulating section 94, and a suction section 71 in addition to the liquid supply sections 90a and 90b described above. Note that, in FIG. 2, the roll body R, the medium 2, the housing 15, and the like are not illustrated. In the description of FIG. 2, a state viewed from the front, which is the +Y direction will be described unless otherwise specified.

The liquid supply sections 90a and 90b are disposed below the medium support section 51. The liquid supply section 90a is, in a direction along the X-axis, disposed so as to protrude in the −X direction beyond an end section of the medium support section 51 in the −X direction. The liquid supply section 90b is, in the direction along the X-axis, provided at a position in the-X direction further from the end section of the medium support section 51 in a +X direction.

Four cartridges 91 are attached to the liquid supply section 90a. Each of the four cartridges 91 can be inserted into and removed from the liquid supply section 90a. The four cartridges 91 are filled with, for example, white ink.

Four cartridges 92 are attached to the liquid supply section 90b. Each of the four cartridges 92 can be inserted into and removed from the liquid supply section 90b. Each of the cartridges 92 is filled with individual color ink of, for example, cyan, magenta, yellow, and black.

The ink with which the cartridges 91 and 92 are filled is not limited to the above, and may include a liquid such as ink exhibiting a color other than the above, clear ink, a treatment liquid, and a cleaning liquid. In the following description, each of color inks and the liquids described above may be collectively referred to simply as ink.

Although not illustrated, each of the cartridges 91 and 92 includes an exterior made of hard resin, a storing section which is provided in the exterior and can store liquid in the storing section, and a supply section for supplying the stored liquid. The storing section includes, for example, a resin sheet provided with a metal thin film. In the storing section, the resin sheet is formed into a bag shape. The supply section seals the storing section. When attached to the printing apparatus 1, the supply section supplies the stored liquid to a pipe connected to the head 61. The number of the cartridges 91 which can be attached to the liquid supply section 90a and the number of the cartridges 92 which can be attached to the liquid supply section 90b are not limited to four.

The liquid sending section 93 is a liquid sending pump, and supplies the color inks from the liquid supply sections 90a and 90b to the head 61. The liquid sending section 93 is disposed below the medium support section 51 and between the liquid supply section 90a and the liquid supply section 90b.

The liquid sending section 93, the four cartridges 91 of the liquid supply section 90a, and the four cartridges 92 of the liquid supply section 90b are connected to each other by pipes (not illustrated). The liquid sending section 93 and the head 61 are connected by individual pipes (not illustrated) for each type of ink. A known liquid sending pump can be used as the liquid sending section 93.

The liquid circulating section 94 is a circulation pump and circulates the white ink in paths such as pipes through which the white ink flows to suppress the occurrence of sedimentation, clogging, or the like of a white pigment. The liquid circulating section 94 is disposed in the vicinity of the liquid supply section 90a in the −X direction.

The liquid circulating section 94 is interposed in the pipes from the cartridges 91 attached to the liquid supply section 90a to the head 61 via the liquid sending section 93. When the liquid circulating section 94 operates, the white ink in the pipes circulates. A known circulation pump can be used as the liquid circulating section 94.

The suction section 71 sucks ink from the head 61 to clean the head 61. The suction section 71 is disposed in the −X direction of the medium support section 51. The carriage 62 and the head 61 can be moved to a position facing the suction section 71 in the up-down direction, the position being in the −X direction further from the position indicated by a solid line in FIG. 2.

In addition, the carriage 62 and the head 61 are moved to a position indicated by a broken line in FIG. 2 at the time of maintenance work using a head cleaning jig which will be described later. That is, the maintenance work of the head 61 is performed by moving the carriage 62 and the head 61 to an end section of the printing apparatus 1 in the −X direction. In the following description, the maintenance work of the head 61 using the head cleaning jig will also be simply referred to as maintenance work. In the printing apparatus 1, the position at which the maintenance work is performed is set to the end section in the −X direction, but is not limited thereto, and the position is appropriately changed according to the configuration or form of the apparatus.

Although not illustrated, a door for maintenance is provided on a side surface of the housing 15 facing the −X direction so as to correspond to the position of the head 61 at the time of the maintenance work. The maintenance work is performed by opening the door for maintenance.

When the head 61 is cleaned by the suction section 71, the carriage 62 is moved to a position where the head 61 faces the suction section 71. Then, the suction section 71 is raised by a driving mechanism (not illustrated) and comes into close contact with the head 61. In this state, by operating a suction pump connected to the suction section 71, the ink is sucked from the plurality of nozzles of the head 61. Accordingly, the ink in the nozzles is discharged, and the ink in the nozzles is renewed.

Although not illustrated, the printing apparatus 1 includes a wiping mechanism. The wiping mechanism wipes off the ink attached to the nozzle surface of the head 61 in the cleaning. Examples of the wiping mechanism include, for example, a known mechanism including a wiping member such as rubber or cloth.

In the printing apparatus 1, solidified ink which is not removed by the cleaning may attach to the nozzle surface and the like. Such attached matter may degrade the performance of the head 61 and the quality of the printed matter. Therefore, in the printing apparatus 1, the attached matter is removed from the head 61 by using the head cleaning jig as necessary. Details of the head cleaning jig and the maintenance work will be described later.

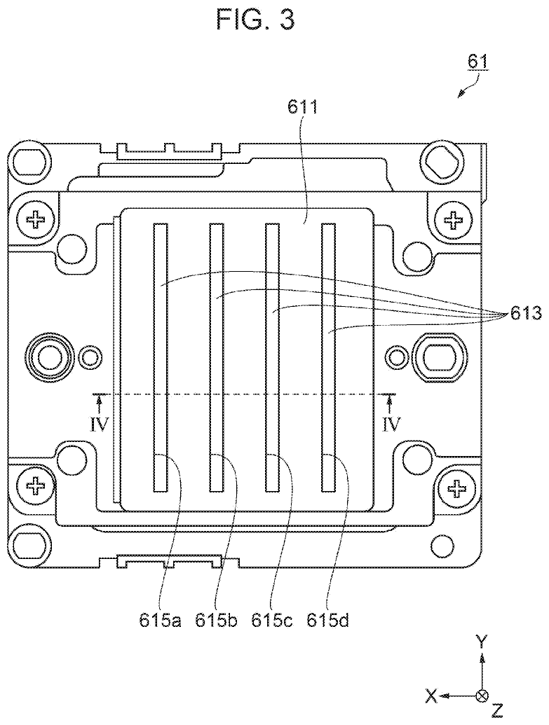

As illustrated in FIG. 3, the head 61 includes a fixing plate 611, a nozzle surface 613, and opening sections 615a, 615b, 615c, and 615d. The head 61 has a rectangular shape when viewed from the −Z direction, with one pair of sides being along the Y-axis and the other pair of sides being along the X-axis. In the following description of FIG. 3, a state viewed from the −Z direction will be described unless otherwise specified.

The fixing plate 611 has a substantially rectangular shape and is disposed at the center of the head 61. The fixing plate 611 is formed of, for example, a sheet metal member made of stainless steel. The fixing plate 611 includes a planar section (not illustrated). The planar section is along the XY plane. The planar section has a rectangular shape. The planar section is provided with the opening sections 615a, 615b, 615c, and 615d.

The opening sections 615a, 615b, 615c, and 615d are through holes that penetrate the fixing plate 611 in a direction along the Z-axis. Each of the opening sections 615a, 615b, 615c, and 615d has a rectangular shape whose longitudinal direction is along the Y-axis. The opening section 615a, the opening section 615b, the opening section 615c, and the opening section 615d are disposed in this order in the −X direction from an end side of the fixing plate 611 in the +X direction. The nozzle surface 613 disposed in the +Z direction of the fixing plate 611 is exposed via each of the opening sections 615a, 615b, 615c, and 615d.

The nozzle surface 613 is provided with a plurality of nozzle rows (not illustrated). Each of the nozzle rows includes a plurality of nozzles arranged along the Y-axis. That is, the plurality of nozzles constituting each of the nozzle rows are arranged along the Y-axis. Each of the plurality of nozzle rows is disposed corresponding to any of the opening sections 615a, 615b, 615c, and 615d, and is exposed in the-Z direction via the fixing plate 611. Each of the nozzle rows individually ejects ink.

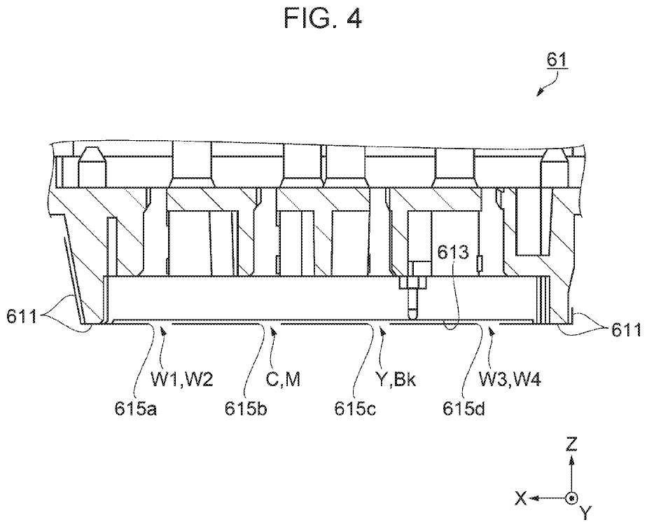

As illustrated in FIG. 4, in the fixing plate 611, an end section in the +X direction and an end section in the −X direction are bent substantially in the +Z direction.

The nozzle surface 613 is disposed in contact with the fixing plate 611 in the +Z direction. In the nozzle surface 613, the nozzle rows W1 and W2 are disposed corresponding to the opening section 615a, the nozzle rows C and M are disposed corresponding to the opening section 615b, the nozzle rows Y and Bk are disposed corresponding to the opening section 615c, and the nozzle rows W3 and W4 are disposed corresponding to the opening section 615d. The nozzle rows are disposed in the order of the nozzle row W1, the nozzle row W2, the nozzle row C, the nozzle row M, the nozzle row Y, the nozzle row Bk, the nozzle row W3, and the nozzle row W4 in the −X direction from an end section of the nozzle surface 613 in the +X direction.

Although not illustrated, the nozzle row W1 includes a plurality of nozzles that eject first white ink. The nozzle row W2 includes a plurality of nozzles that eject second white ink. The nozzle row C includes a plurality of nozzles that eject cyan ink. The nozzle row M includes a plurality of nozzles that eject magenta ink. The nozzle row Y includes a plurality of nozzles that eject yellow ink. The nozzle row Bk includes a plurality of nozzles that eject black ink. The nozzle row W3 includes a plurality of nozzles that eject third white ink. The nozzle row W4 includes a plurality of nozzles that eject fourth white ink.

The first white ink, the second white ink, the third white ink, and the fourth white ink may be the same white ink, or may be different types of white ink.

Although the nozzle surface 613 is illustrated as a continuous flat surface in FIG. 4, the present disclosure is not limited thereto. For example, the head 61 may include four head chips corresponding to each of the nozzle rows W1 and W2, the nozzle rows C and M, the nozzle rows Y and Bk, and the nozzle rows W3 and W4, and the nozzle surface 613 may be divided into four corresponding to the four head chips. However, even in this case, each of the divided nozzle surfaces 613 is still exposed downward via the fixing plate 611.

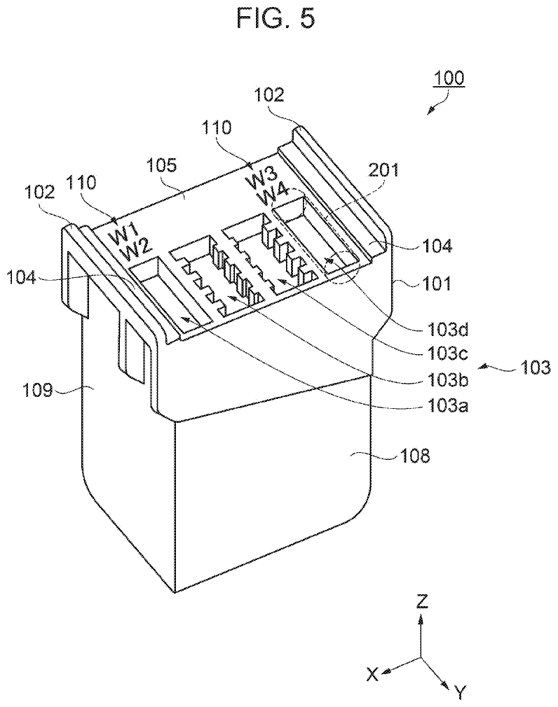

As illustrated in FIG. 5, the head cleaning jig 100 includes a main body section 101, a grip section 108, and a limiting wall 109. The head cleaning jig 100 is held by a hand of an operator to perform the maintenance work. In the head cleaning jig 100, the main body section 101 is disposed on the upper side, and the grip section 108 and the limiting wall 109 are disposed on the lower side of the main body section 101.

The main body section 101 has a rectangular shape when viewed from above, with one set of sides of two sets of sides facing each other being along the X-axis and the other set of sides being along the Y-axis in the orientation at the time of the maintenance work. The main body section 101 includes, in a region facing upward, a pair of guide ribs 102, four holding sections 103a, 103b, 103c, and 103d, a pair of contact sections 104, and an introduction section 105. In FIG. 5, a cleaning member 201 held by the holding section 103d is indicated by a broken line.

Each of the pair of guide ribs 102 is disposed on corresponding one of the pair of sides along the Y-axis of the main body section 101 in the orientation at the time of the maintenance work. The pair of guide ribs 102 protrude upward when viewed from the +Y direction. When viewed from above, the length of each of the guide ribs 102 along the Y-axis is substantially equal to the length of the main body section 101 along the Y-axis.

The pair of guide ribs 102 contribute to positioning of the head cleaning jig 100 with respect to the head 61 in the maintenance work. The guide ribs 102 are not limited to a pair, and, for example, any one of the guide ribs 102 may be provided. However, from the viewpoint of ensuring the positioning, it is preferable that a pair of guide ribs 102 are provided.

The holding sections 103a, 103b, 103c, and 103d are disposed on a surface facing upward between the pair of guide ribs 102, in other words, on an upper surface of the main body section 101. Each of the holding sections 103a, 103b, 103c, and 103d can hold the cleaning member 201. The cleaning member 201 comes into contact with the nozzles and the peripheries of the nozzles, and wipes them to remove the attached matter. In the following description, the holding sections 103a, 103b, 103c, and 103d may be collectively referred to as holding sections 103.

The holding section 103 includes a plurality of the holding sections, and each of the holding sections 103 is provided for corresponding one of the plurality of nozzle rows, the plurality of nozzles described above being arranged in each of the plurality of nozzle rows. The holding sections 103 are arranged along the X-axis. Each of the holding sections 103 has a substantially rectangular shape when viewed from above, and the longitudinal direction of each of the holding sections 103 is along the Y-axis. Each of the holding sections 103 is recessed downward from the upper surface of the main body section 101. The cleaning member 201 is fitted and held in the recess of the holding sections 103. Each of the holding sections 103 can hold the cleaning member 201 corresponding to each of the nozzle rows.

The contact sections 104 are disposed inside the respective guide ribs 102 and form a pair. The contact sections 104 are disposed in the −X direction and the +X direction along each of the guide ribs 102 on the upper surface of the main body section 101. Each of the contact sections 104 is a substantially rectangular region whose longitudinal direction is along the Y-axis when viewed from above. The substantially rectangular region is along the XY plane. Each of the contact sections 104 protrudes upward from the upper surface of the main body section 101, and is located below upper ends of the pair of guide ribs 102. The contact sections 104 are located at the same position in the direction along the Z-axis with respect to the upper surface of the main body section 101, that is, at the same height.

The contact sections 104 come into contact with the head 61 or the like at the time of the maintenance work to separate the plurality of nozzles of the nozzle surface 613 and the holding sections 103 at a predetermined interval.

The introduction section 105 is provided on the upper surface of the main body section 101 in the extension direction with respect to the holding section 103, that is, in the −Y direction of the holding section 103. The introduction section 105 is a region along the XY plane and constitutes a part of the upper surface of the main body section 101.

The introduction section 105 can face the head 61 in the maintenance work. The guide ribs 102 extend over a range from the introduction section 105 to the holding section 103 in a direction along the Y-axis. In the maintenance work, before the cleaning member 201 comes into contact with the nozzle surface 613, the introduction section 105 and the nozzle surface face each other in the up-down direction. Accordingly, a stage of positioning of the head cleaning jig 100 with respect to the head 61 is secured, and the maintenance work is easily started.

A plurality of holding sections 103 have engraved marks 110. The engraved marks 110 are disposed in the introduction section 105 in the −Y direction of each of the holding sections 103. Each of the engraved marks 110 is provided for corresponding one of the holding sections 103a, 103b, 103c, and 103d, and corresponds to the plurality of nozzle rows with which the cleaning member 201 held by each of the holding sections 103 comes into contact.

FIG. 5 illustrates an example in which “W1, W2” is disposed in the −Y direction of the holding section 103a and “W3, W4” is disposed in the −Y direction of the holding section 103d as the engraved marks 110. “W1, W2” of the engraved mark 110 indicates the nozzle rows W1 and W2, and “W3, W4” of the engraved mark 110 indicates the nozzle rows W3 and W4. Note that “C, M” may be provided as the engraved mark 110 corresponding to the nozzle rows C and M, and “Y, Bk” may be provided as the engraved mark 110 corresponding to the nozzle rows Y and Bk.

The operator causes the printing apparatus 1 to print a nozzle check pattern of the head 61 to check whether or not there is a nozzle that does not normally eject among the plurality of nozzles. In a case where there is a nozzle that does not eject normally, the operator performs the maintenance work by attaching the cleaning member 201 on the holding section 103 corresponding to the nozzle with reference to the engraved mark 110. Accordingly, it is easy to specify the holding section 103 to which the cleaning member 201 is to be attached among the holding sections 103, and the convenience of the operator is improved. The arrangement of the nozzle check pattern of the head 61 printed by the printing apparatus 1 may correspond to the arrangement of the holding sections 103. Further, the engraved marks 110 may be replaced with stick-type display objects such as labels.

The grip section 108 and the limiting wall 109 extend downward from the main body section 101. The grip section 108 is disposed on the side opposite to the upper surface side of the main body section 101 on which the cleaning member 201 is held by the holding section 103. The grip section 108 can be gripped by an operator's hand. The grip section 108 makes it easy to hold the head cleaning jig 100, and the workability of the maintenance is further improved.

The limiting wall 109 is provided so as to project in a wall shape in the −Y direction from an end of the grip section 108 in the +X direction. As will be described in detail later, the limiting wall 109 contributes to the operator correctly gripping the head cleaning jig 100. The limiting wall 109 includes a region along a YZ plane. When viewed from above, the length of the region along the Y-axis is substantially equal to the length of the guide rib 102 along the Y-axis.

The main body section 101 including the pair of guide ribs 102 and each of the contact sections 104 is made of resin. This makes the coefficient of friction between the guide ribs 102 and the contact sections 104, and a member such as the head 61 with which the guide ribs 102 and the contact sections 104 come into contact, relatively low. Therefore, the guide ribs 102 and the contact sections 104 easily slide with respect to the member, and the workability of the maintenance is further improved.

Examples of the resin include fluororesin such as polytetrafluoroethylene, polyoxymethylene, and polyether ether ketone. In the present embodiment, the main body section 101, the grip section 108, and the limiting wall 109 are integrally molded from polyoxymethylene. The head cleaning jig of the present disclosure is not limited to an integrally molded product of resin. For example, components other than the guide ribs 102 and the contact sections 104 may be made of another material such as metal.

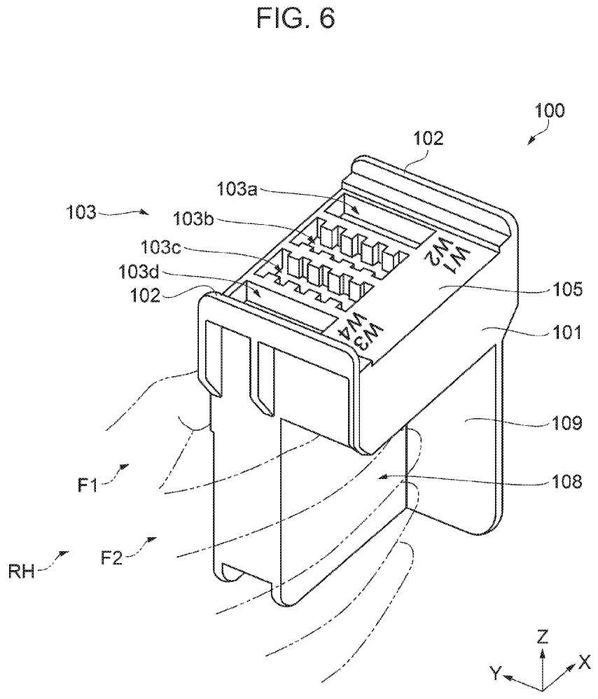

As illustrated in FIG. 6, when the head cleaning jig 100 is held by a right hand RH, a thumb F1 is positioned on a surface of the grip section 108 facing the +Y direction, and an index finger F2 and other fingers are positioned on a surface facing the −Y direction. That is, the operator pinches and holds the head cleaning jig 100 with the right hand RH from the −X direction. If the operator tries to grip the head cleaning jig 100 with the right hand RH from the +X direction, the limiting wall 109 becomes an obstacle. The limiting wall 109 defines a direction in which the grip section 108 is gripped.

As a result, the head cleaning jig 100 is correctly gripped, and the head cleaning jig 100 comes into contact with the head 61 in an appropriate orientation. Therefore, for example, even if the arrangement of the nozzle rows on a planar section 611a of the head 61 is asymmetric in the direction along the X-axis, the head cleaning jig 100 can come into contact in a correct orientation.

In a case where the maintenance work is performed by gripping the head cleaning jig 100 with the right hand RH, the operator stands facing the +X direction on the −X direction side of the printing apparatus 1. Then, the maintenance work is performed by inserting the right hand RH gripping the head cleaning jig 100 from the side surface where the door for maintenance described above is opened.

Although not illustrated, in a case where the head cleaning jig 100 is held by a left hand, the head cleaning jig 100 is gripped by placing the thumb on the surface facing the −Y direction and placing the index finger and other fingers on the surface facing the +Y direction in the grip section 108. Also in this case, a direction in which the grip section 108 is gripped is defined by the limiting wall 109.

Even in a case where the maintenance work is performed by gripping the head cleaning jig 100 with the left hand, the operator stands facing the +X direction on the −X direction side of the printing apparatus 1. Then, the maintenance work is performed by inserting the left hand gripping the head cleaning jig 100 from the side surface where the door for maintenance described above is opened.

Note that the arrangement of the door for maintenance in the housing 15 and the arrangement of the grip section 108 and the limiting wall 109 in the head cleaning jig 100 are merely examples and are not limited to the above. The orientation in which the grip section 108 and the limiting wall 109 are formed with respect to the guide ribs 102 and the holding sections 103 may be changed depending on the posture of the operator that facilitates the maintenance. In the head cleaning jig of the present disclosure, the grip section 108 and the limiting wall 109 are not essential components, and may be omitted. When the grip section 108 and the limiting wall 109 are omitted, the operator grips the main body section 101.

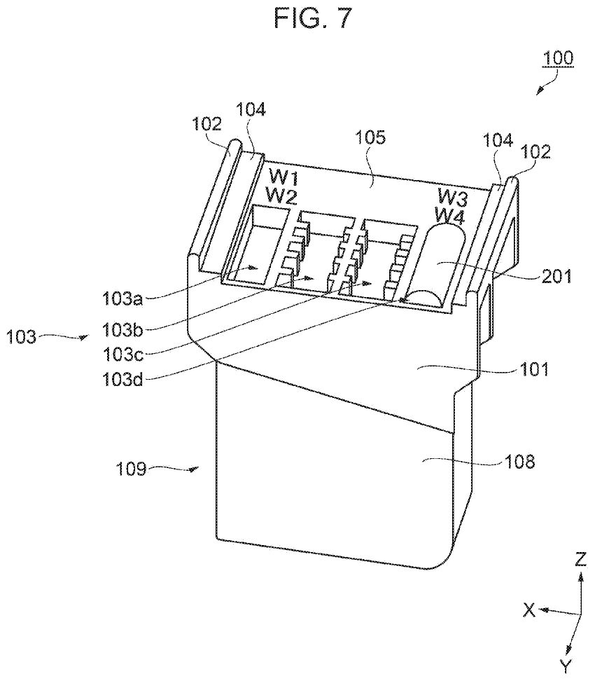

As illustrated in FIG. 7, the cleaning member 201 has a cylindrical shape. The cleaning member 201 is held by the holding section 103 such that the axial direction of the cylinder is along the Y-axis. A side surface of the cleaning member 201 comes into contact with the nozzles. The cleaning member 201 is not limited to the cylindrical shape, and may be a polygonal pillar shape such as a quadrangular pillar shape. FIG. 7 illustrates a state in which the cleaning member 201 is attached only to the holding section 103d.

In the maintenance work, the cleaning member 201 comes into contact with the nozzles and slides to wipe off the attached matter on the nozzles and the peripheries of the nozzles. The cleaning member 201 is a porous member having elasticity. Since the cleaning member 201 is porous, the attached matter is easily picked up, and appropriate elasticity is imparted.

Examples of the material of the cleaning member 201 include resins such as polyurethane, polyolefin, and polyvinyl alcohol. A commercially available product may be used as the cleaning member 201. Examples of the commercially available product include TECHNOPOROUS (registered trademark) manufactured by Fushimi Pharmaceutical Co., Ltd. The cleaning member 201 may be impregnated with water, a detergent, and the like.

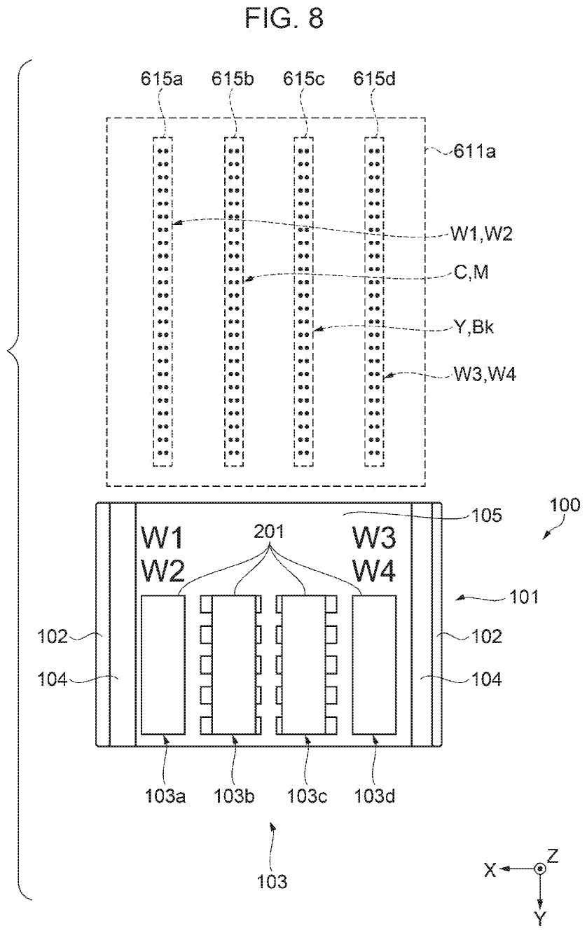

As illustrated in FIG. 8, in a see-through view from above, the planar section 611a of the fixing plate 611 has a rectangular shape, with one pair of sides being along the Y-axis and the other pair of sides being along the X-axis. As described above, the head 61 has a rectangular shape when viewed from the −Z direction, with one pair of sides being along the Y-axis and the other pair of sides being along the X-axis. That is, four sides of the head 61 are each parallel to the corresponding side of four sides of the planar section 611a. In FIG. 8, the planar section 611a, the opening sections 615a, 615b, 615c, and 615d, and the like are illustrated by broken lines in the see-through view from above. As will be described in detail later, the positional relationship between the planar section 611a and the head cleaning jig 100 in FIG. 8 is an arrangement immediately before the maintenance work is started.

The nozzle rows W1 and W2 in which a plurality of nozzles are arranged are disposed in the opening section 615a. The nozzle rows C and M in which a plurality of nozzles are arranged are disposed in the opening section 615b. The nozzle rows Y and Bk in which a plurality of nozzles are arranged are disposed in the opening section 615c. The nozzle rows W3 and W4 in which a plurality of nozzles are arranged are disposed in the opening section 615d. The nozzle rows W1, W2, C, M, Y, Bk, W3, and W4 are along the Y-axis. That is, the plurality of nozzles constituting each of the nozzle rows are arranged along one side of the head 61, and are also arranged along sides of the planar section 611a, the sides facing each other in the direction along the X-axis.

The guide ribs 102 extend so as to correspond to the one side of the head 61 and the sides of the planar section 611a, the sides facing each other in the direction along the X-axis. In the direction along the X-axis, the interval between the pair of guide ribs 102 is slightly wider than the interval between the opposing sides of the planar section 611a. Thus, the pair of guide ribs 102 can move in the direction along the Y-axis with respect to the planar section 611a while putting the planar section 611a between the pair of guide ribs 102.

The pair of guide ribs 102 define the position in the direction along the X-axis with respect to the planar section 611a during the maintenance work. That is, the pair of guide ribs 102 have a function of causing the head cleaning jig 100 to follow the sides of the planar section 611a that face each other in the direction along the X-axis. In other words, the pair of guide ribs 102 cause the head cleaning jig 100 to follow at least one side of the head 61. In addition, as will be described in detail later, the position of the head cleaning jig 100 in the direction along the Z-axis with respect to the planar section 611a is defined by the contact sections 104 during the maintenance work.

Each of the holding sections 103 can hold the cleaning member 201. When the cleaning member 201 is held by the holding section 103, the longitudinal direction of the cleaning member 201 is along the Y-axis and the extension direction of the guide ribs 102.

In the direction along the X-axis, because the pair of guide ribs 102 define the arrangement of the planar section 611a and the head cleaning jig 100, the arrangement of the cleaning member 201 with respect to each of the nozzle rows W1, W2, C, M, Y, Bk, W3, and W4 is also defined. That is, during the maintenance work, each of the cleaning members 201 can come into contact with the corresponding nozzle rows W1, W2, C, M, Y, Bk, W3, and W4. The cleaning member 201 held by the holding section 103a comes into contact with the nozzle rows W1 and W2, the cleaning member 201 held by the holding section 103b comes into contact with the nozzle rows C and M, the cleaning member 201 held by the holding section 103c comes into contact with the nozzle rows Y and Bk, and the cleaning member 201 held by the holding section 103d comes into contact with the nozzle rows W3 and W4. That is, each of the holding sections 103 holds the cleaning member 201 such that the side surface of the corresponding cleaning member 201 can face the nozzles.

In the maintenance work, first, from the state illustrated in FIG. 8, the head cleaning jig 100 is moved in the −Y direction with respect to the planar section 611a until the introduction section 105 and the planar section 611a face each other. At this time, the position of each of the cleaning members 201 in the direction along the X-axis with respect to the planar section 611a is determined by the planar section 611a being put between the pair of guide ribs 102.

At the same time as the positioning in the direction along the X-axis is performed by the pair of guide ribs 102, the pair of contact sections 104 and regions at both ends of the planar section 611a in the direction along the X-axis come into contact with each other. Thus, the head cleaning jig 100 is positioned with respect to the planar section 611a in the direction along the axis, and the cleaning member 201 is positioned with respect to the planar section 611a in the direction along the Z-axis. In addition, since the introduction section 105 is disposed, it is possible to perform the positioning before each of the cleaning members 201 comes into contact with the planar section 611a.

Next, the head cleaning jig 100 is further moved in the −Y direction, and the corresponding cleaning member 201 comes into contact with each of the nozzle rows W1, W2, C, M, Y, Bk, W3, and W4. When the pair of guide ribs 102 are moved along the one side of the head 61, the moving direction of the pair of guide ribs 102 coincides with the longitudinal direction of each of the cleaning members 201. Therefore, the wiping length of each of the peripheries of the nozzles by the cleaning member 201 becomes long, and dirt of the peripheries of the nozzles is easily removed.

Then, the head cleaning jig 100 is further moved in the −Y direction, and the cleaning members 201 are slid to the end sections of the nozzle rows W1, W2, C, M, Y, Bk, W3, and W4 in the −Y direction. After sliding the cleaning members 201 to the end sections in the −Y direction, the head cleaning jig 100 is turned back and moved in the +Y direction, and the cleaning members 201 are slid to the end sections of the nozzle rows W1, W2, C, M, Y, Bk, W3, and W4 in the +Y direction. The above movement is repeated a plurality of times to remove the attached matter by each of the cleaning members 201.

The number and the arrangement of the holding sections 103 with respect to the nozzle rows W1, W2, C, M, Y, Bk, W3, and W4 are not limited to the above. For example, one holding section 103 may be provided, and a configuration in which one cleaning member 201 is held by one holding section 103 may be employed. In this configuration, when viewed from above, the longitudinal direction of the holding section 103 and the cleaning member 201 is along the X-axis, and one cleaning member 201 comes into contact with all of the nozzle rows W1, W2, C, M, Y, Bk, W3, and W4.

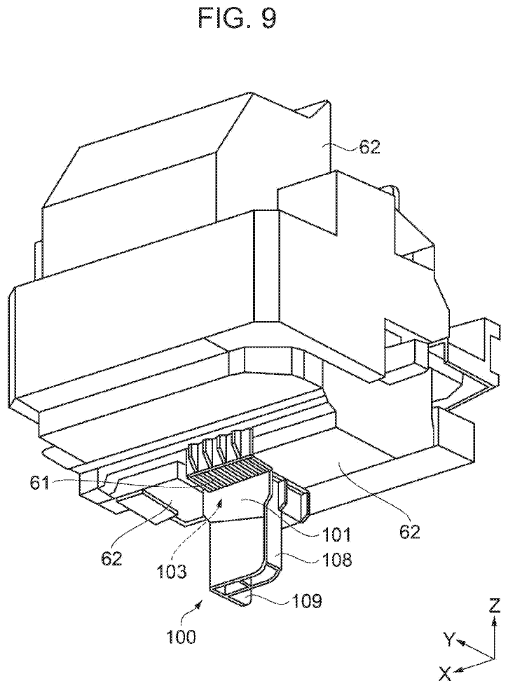

As illustrated in FIG. 9, in the maintenance work, the head cleaning jig 100 is disposed so as to come into contact, from below, with the planar section 611a facing downward. At this time, the head cleaning jig 100 is in a posture in which the holding section 103 of the main body section 101 faces upward with respect to the grip section 108 and the limiting wall 109 which are positioned below. Note that, FIG. 9 illustrates a state in which the head cleaning jig 100 has moved to the vicinity of the end section of the planar section 611a in the −Y direction.

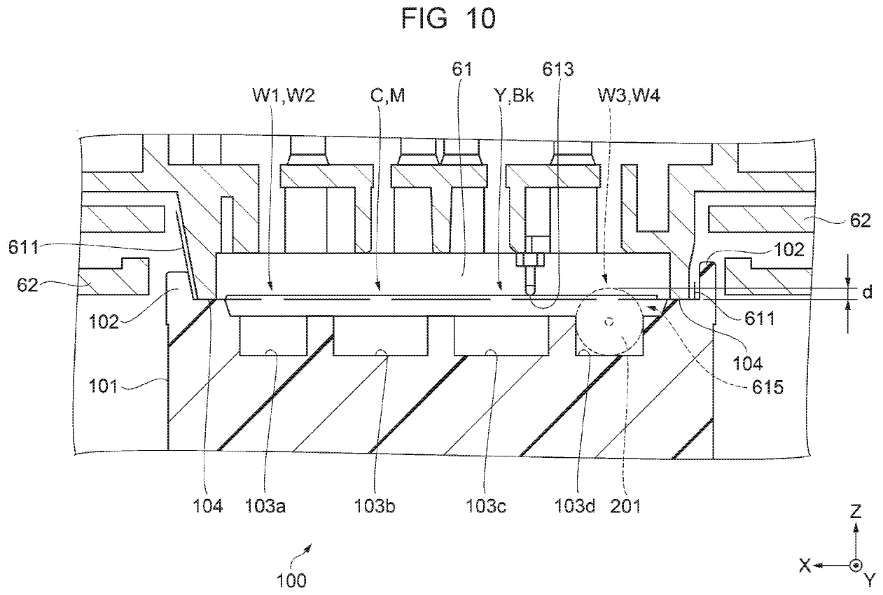

As illustrated in FIG. 10, the positioning of the head cleaning jig 100 with respect to the head 61 is performed by contacting each of the sections of the head 61 with the pair of guide ribs 102 and the pair of contact sections 104. Specifically, the end section of the fixing plate 611 in the +X direction including an end side of the planar section 611a in the +X direction comes into contact with an inner side of the guide rib 102 in the +X direction. In addition, the end section in the −X direction of the fixing plate 611 including the end side in the −X direction of the planar section 611a comes into contact with the inner side of the guide rib 102 in the −X direction. Accordingly, the positions of the holding section 103 and the cleaning member 201 in the direction along the X-axis are determined with respect to the nozzles (not illustrated) constituting the nozzle rows W1, W2, C, M, Y, Bk, W3, and W4.

Further, the contact section 104 in the +X direction comes into contact with an end section of the planar section 611a in the +X direction, and the contact section 104 in the −X direction comes into contact with an end section of the planar section 611a in the −X direction. Accordingly, the position of the holding section 103 in the direction along the Z-axis with respect to the planar section 611a is determined. In this way, the head cleaning jig 100 is positioned with respect to the head 61. Note that, in FIG. 10, the cleaning member 201 is held only by the holding section 103d.

As described above, at the time of the maintenance work, the pair of guide ribs 102 follow the sides of the planar section 611a facing each other in the direction along the X-axis, in other words, the one side of the head 61. In this state, the nozzles constituting the nozzle rows W1, W2, C, M, Y, Bk, W3, and W4 and the cleaning members 201 held by the holding sections 103 can come into contact with each other.

Since the cleaning member 201 protrudes upward from the holding section 103d when viewed from the +Y direction, the cleaning member 201 and the planar section 611a overlap each other by a distance d in the maintenance work. As described above, since the cleaning member 201 has elasticity, the cleaning member 201 is compressed by the distance d and comes into contact with the nozzles with the reaction force. By the cleaning member 201 sliding in this state, the attached matter on the nozzles and the peripheries of the nozzles is easily removed. The predetermined interval between the plurality of nozzles and the holding section 103, which is generated when the contact sections 104 come into contact with the head 61 or the like, is set such that the cleaning member 201 comes into contact with the nozzles at an appropriate pressure in consideration of the amount of deflection of the cleaning member 201.

In this way, since the degree of contact of the cleaning member 201 with the nozzles is defined, it is not necessary to adjust the force when the head cleaning jig 100 is brought into contact with the head 61, and the workability of the maintenance is further improved. In addition, as in the head 61, even in a case where the nozzle surface 613 is disposed in a region which is recessed in a concave shape with respect to the planar section 611a, the cleaning member 201 can be brought into contact with the peripheries of the nozzles.

The positioning of the head cleaning jig 100 with respect to the head 61 is not limited to using each section of the head 61 as a reference. The positioning may be performed by contacting each portion of the carriage 62 with the pair of guide ribs 102 and the pair of contact sections 104.

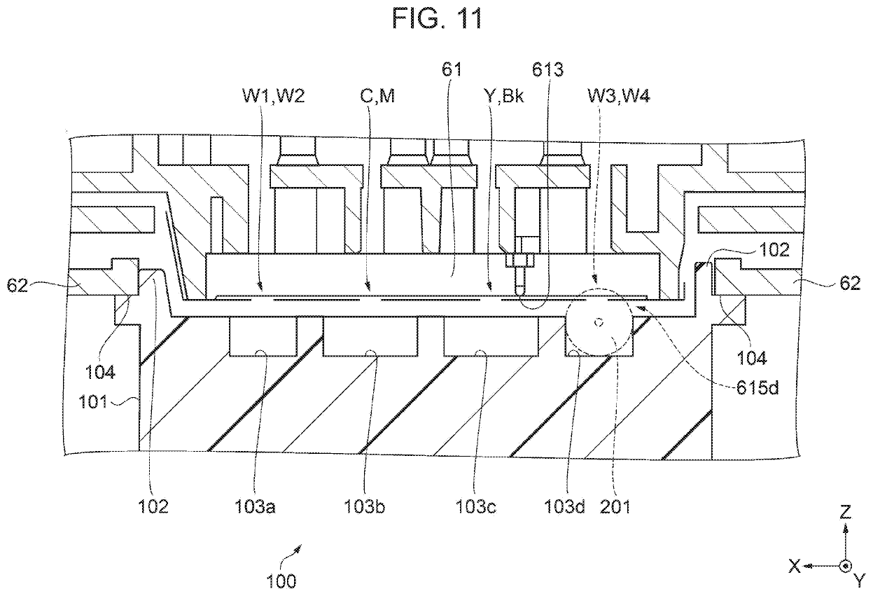

For example, as illustrated in FIG. 11, the contact section 104 is provided so as to protrude in the +X direction from the guide rib 102 in the +X direction, and the contact section 104 is provided so as to protrude in the −X direction from the guide rib 102 in the −X direction. The pair of guide ribs 102 and the pair of contact sections 104 are brought into contact with parts of the carriage 62 to position the head cleaning jig 100 with respect to the head 61.

Specifically, in the guide rib 102 in the +X direction, a corner of the carriage 62 disposed in the +X direction of the head 61 is brought into contact with a surface of the guide rib 102 in the +X direction and a surface of the contact section 104 facing upward. In the guide rib 102 in the −X direction, a corner of the carriage 62 disposed in the −X direction of the head 61 is brought into contact with a surface of the guide rib 102 in the −X direction and a surface of the contact section 104 facing upward. In the carriage 62, the regions of the corners with which the guide ribs 102 and the contact sections 104 come into contact extend along the Y-axis, similarly to the head 61 and the planar section 611a.

Accordingly, the positions of the holding sections 103 and the cleaning members 201 in the direction along the X-axis are determined with respect to the nozzles (not illustrated) constituting the nozzle rows W1, W2, C, M, Y, Bk, W3, and W4. In addition, the positions of the holding sections 103 with respect to the planar section 611a in the direction along the Z-axis are determined. As described above, the head cleaning jig 100 is positioned with respect to the head 61, and the pair of guide ribs 102 can be in a state to follow the one side of the head 61.

In the positioning of the head cleaning jig 100 with respect to the head 61, the reference of the positioning in the direction along the X-axis may be the end section of the planar section 611a, and the reference of the positioning in the direction along the Z-axis may be the corner of the carriage 62. Further, in the positioning, the reference of the positioning in the direction along the X-axis may be the corner of the carriage 62, and the reference of the positioning in the direction along the Z-axis may be the end section of the planar section 611a.

The present embodiment provides the following effects.

The workability of the maintenance can be improved. Specifically, the guide rib 102 follows the one side of the head 61, so that the nozzles of the head 61 and the cleaning member 201 are in a position where they can be brought into contact with each other. That is, the positioning of the cleaning member 201 with respect to the nozzles is facilitated by the guide rib 102 without visually recognizing the positions of the nozzles by a mirror as in the related art. Therefore, it is possible to provide the head cleaning jig 100 that improves the workability of the maintenance.

What is claimed is:

1. A head cleaning jig comprising:
a guide rib configured to follow at least one side of a head that has a rectangular shape and ejects liquid; and
a holding section that holds a cleaning member for wiping nozzles arranged along the one side, wherein
the nozzles and the cleaning member held by the holding section are configured to be brought into contact with each other in a state where the guide rib follows the one side.

2. The head cleaning jig according to claim 1, further comprising a contact section for separating the nozzles and the holding section from each other at a predetermined interval.

3. The head cleaning jig according to claim 1, further comprising
a grip section that is disposed on a side opposite to a side on which the cleaning member is held by the holding section, and that is configured to be gripped; and
a limiting wall that is provided so as to project from an end of the grip section and defines a direction in which the grip section is gripped.

4. The head cleaning jig according to claim 1, wherein the guide rib is made of resin.

5. The head cleaning jig according to claim 1, wherein
the guide rib extends corresponding to the one side of the head, and
the holding section is configured to hold the cleaning member such that a longitudinal direction of the cleaning member is along an extension direction of the guide rib.

6. The head cleaning jig according to claim 5, further comprising an introduction section that is provided in the extension direction with respect to the holding section and is configured to face the head, wherein
the guide rib extends over a range from the introduction section to the holding section.

7. The head cleaning jig according to claim 1, wherein
the cleaning member has a cylindrical shape, and
the holding section holds the cleaning member such that a side surface of the cleaning member is configured to face the nozzles.

8. The head cleaning jig according to claim 1, wherein the holding section comprises a plurality of holding sections, and each of the holding sections is provided for corresponding one of nozzle rows, the nozzles being arranged in each of the nozzle rows.

9. The head cleaning jig according to claim 8, wherein the plurality of holding sections have engraved marks corresponding to the nozzle rows.
